(19) United States
(12) Patent Application Publication
(10) Pub. No.: US 2024/0323687 A1
(43) Pub. Date: Sep. 26, 2024

(54) SECURE AND EFFICIENT ENROLLMENT OF VEHICLE-TO-EVERYTHING COMMUNICATION

(71) Applicant: FCA US LLC, Auburn Hills, MI (US)

(72) Inventors: Rejani Syamala, Troy, MI (US); Michele Provera, Moncalieri (IT)

(21) Appl. No.: 18/186,345

(22) Filed: Mar. 20, 2023

(51) Int. Cl. H04W 12/069; H04W 4/44

(52) U.S. Cl. CPC H04W 12/069; H04W 4/44

(57) ABSTRACT

A vehicle-to-everything (V2X) enrollment method and communication system of a vehicle includes a transceiver configured for communication with other original equipment manufacturer (OEM) vehicles and an OEM backend system, and a controller in communication with the transceiver and configured to perform a V2X enrollment process. The V2X enrollment process includes, during a first phase, transmitting an identity certificate request to the OEM backend system, and receiving and securely storing a signed identity certificate from the OEM backend system. During a subsequent second phase, the enrollment process includes securely connecting and authenticating with the OEM backend system using the signed identify certificate, and receiving and securely storing a V2X enrollment certificate from the OEM backend system.

### FIELD

The present application generally relates to vehicle-to-everything (V2X) communication and, more particularly, to techniques for secure and efficient enrollment of vehicle connectivity units for V2X communication.

### BACKGROUND

Vehicle-to-everything (V2X) communication systems are used for vehicles (e.g., vehicles of a same original equipment manufacturer, or OEM) and/or road-side units to constantly share information with each other using an authenticated and secure mechanism. For example, information can be shared to improve road safety (crash prevention, congestion mitigation, etc.), to reduce emissions, and/or to provide other value-added services for the transportation experience. V2X requires vehicles to periodically obtain authorization certificates for trust/security of the messages exchanged. Standardization of this requirement is available in various regions, mostly focused on the IEEE 1609.2 and ETSI standards. Conventional V2X enrollment methods currently suffer from difficult/complex authorization and also the requirement for specialized hardware (e.g., radio/infotainment units). Accordingly, while such conventional vehicle V2X communication systems do work well for their intended purpose, there exists an opportunity for improvement in the relevant art.

### SUMMARY

According to one example aspect of the invention, a vehicle-to-everything (V2X) communication system of a vehicle is presented. In one exemplary implementation, the V2X communication system comprises a transceiver configured for communication with other original equipment manufacturer (OEM) vehicles and an OEM backend system and a controller in communication with the transceiver and configured to perform a V2X enrollment process including: during a first phase, transmitting an identity certificate request to the OEM backend system and receiving and securely storing a signed identity certificate from the OEM backend system; and during a subsequent second phase: securely connecting and authenticating with the OEM backend system using the signed identify certificate, and receiving and securely storing a V2X enrollment certificate from the OEM backend system.

In some implementations, the controller is further configured to transmit a V2X enrollment status to the OEM backend system upon receiving and securely storing the V2X enrollment certificate. In some implementations, transmitting the V2X enrollment status to the OEM backend system indicates that the V2X communication system is enrolled and authenticated for V2X communication with other same or different OEM vehicles and/or road-side units. In some implementations, the controller is part of a generic hardware vehicle connectivity unit. In some implementations, the generic hardware vehicle connectivity unit is provided by a third-party supplier that does not have access to the OEM backend system.

According to another example aspect of the invention, a V2X enrollment method for a vehicle is presented. In one exemplary implementation, the method comprises providing a transceiver configured for communication with other OEM vehicles and an OEM backend system and a controller in communication with the transceiver, performing, by the controller and using the transceiver, a V2X enrollment process including: during a first phase: transmitting an identity certificate request to the OEM backend system and receiving and securely storing a signed identity certificate from the OEM backend system, and during a subsequent second phase: securely connecting and authenticating with the OEM backend system using the signed identify certificate and receiving and securely storing a V2X enrollment certificate from the OEM backend system.

In some implementations, the method further comprises transmitting, by the controller and using the transceiver, a V2X enrollment status to the OEM backend system upon receiving and securely storing the V2X enrollment certificate. In some implementations, transmitting the V2X enrollment status to the OEM backend system indicates that the V2X communication system is enrolled and authenticated for V2X communication with other same or different OEM vehicles and/or road-side units. In some implementations, the controller is part of a generic hardware vehicle connectivity unit. In some implementations, the generic hardware vehicle connectivity unit is provided by a third-party supplier that does not have access to the OEM backend system.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example vehicle-to-everything (V2X) communication system according to the principles of the present application;

FIGS. 2A-2B are a functional block diagram and a communication flow diagram illustrating an example V2X enrollment process according to the principles of the present application; and

FIG. 3 is a flow diagram of an example V2X enrollment method for a vehicle according to the principles of the present application.

### DESCRIPTION

As previously discussed, conventional vehicle-to-everything (v2X) communication systems suffer from a complex/costly V2X enrollment certificate authentication process. Accordingly, a new innovative procedure and technique that allows an original equipment manufacturer (OEM) to provision the vehicle connectivity unit out of the factory using a unique software-based authorization mechanism. In an exemplary implementation, this generally involves two phases. In a first phase (phase 1), a digital identity is created in a physically secure location (e.g., in-plant during vehicle build). In a second phase (phase 2), the vehicle connectivity module obtains a V2X enrollment certificate in the physically secure location by setting up a secure connection to the manufacturer's public key identity (PKI) using the digital identity (from phase 1). The potential benefits include reduced costs due improved enrollment efficiency in addition to the capability of using generic hardware, as well as increased security.

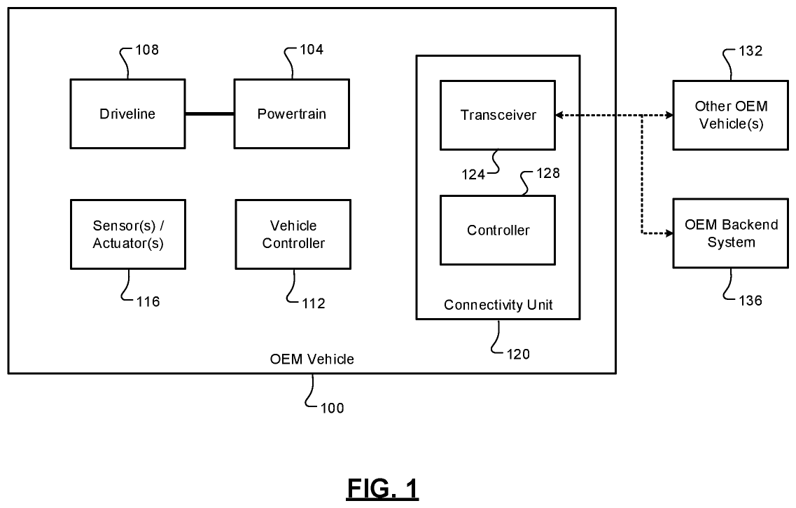

Referring now to FIG. 1, a functional block diagram of an example OEM vehicle 100 in a V2X communication environment according to the principles of the present application is illustrated. The vehicle 100 generally comprises traditional operation components such as a powertrain 104, a driveline 108, a vehicle controller 112, and sensor(s)/actuator(s) 116. It will be appreciated that these components are merely shown/illustrated for descriptive purposes and the vehicle 100 could include a wide array of other suitable components. The vehicle 100 also comprises a vehicle connectivity unit 120, which generally comprises a transceiver 124 and a controller 128 (e.g., a communication controller). The connectivity unit 120, via the transceiver 124, is configured for V2X communication with other OEM vehicle(s) 132 and an OEM backend system 136. The OEM backend system 136 could be located, for example, at a secure facility operated by the OEM.

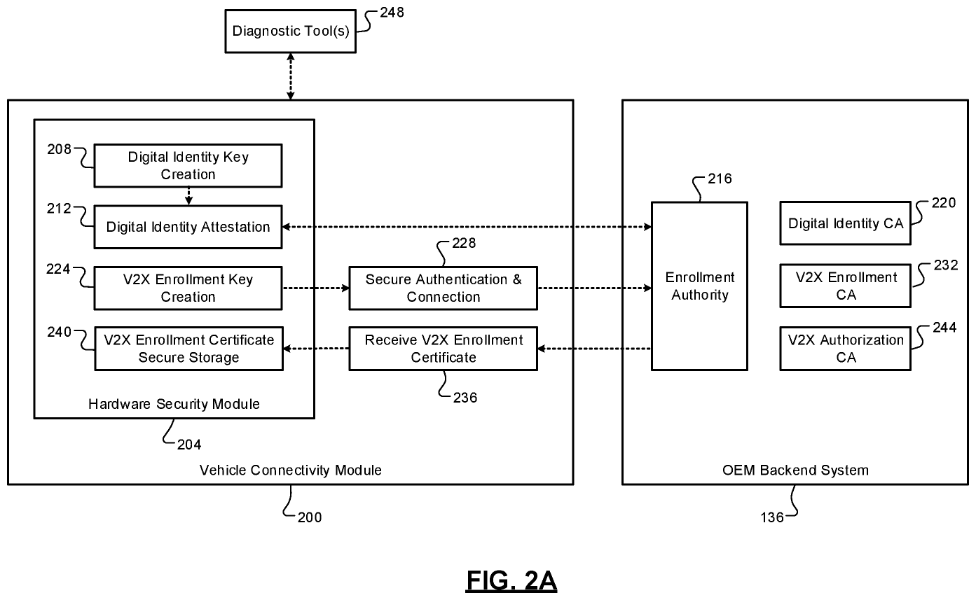

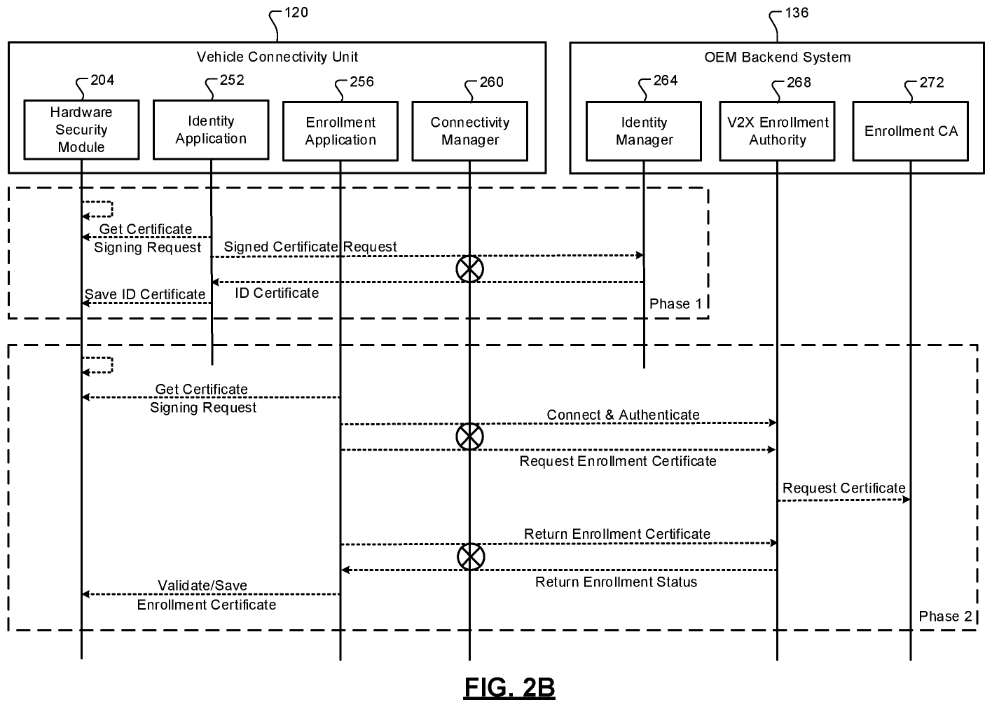

Referring now to FIGS. 2A-2B, a functional block diagram (FIG. 2A) and a communication flow diagram (FIG. 2B) for an example V2X enrollment process according to the principles of the present application are illustrated. In FIG. 2A, a vehicle connectivity module 200 (e.g., implemented by controller 128) comprises a hardware security module 204 having a digital identity key creation block 208 and a digital identity attestation block 212. A digital identity key is created at 208 and attested to at 212 before being provided to an enrollment authority 216 at the OEM backend system 136. The OEM backend system 136 further comprises certificate authorities (CA's): a digital identify CA 220, a V2X enrollment CA 224, and a V2X authorization CA 244. The hardware security module 204 further comprises a V2X enrollment key creation block 228 and a V2X enrollment certificate secure storage block 240.

When a V2X enrollment key is created at 224, a secure and authenticated connection (using the digital identity) is created at block 228 with the enrollment authority 216. The enrollment authority 216 in response returns/provides a V2X enrollment certificate to block 236, which is then securely stored at 240. Future V2X authorization is then managed by the enrollment authority 216 using the V2X authorization CA 244. Diagnostic tool(s) 248 are also provided for V2X communication (identity/certificate) diagnostics at the vehicle connectivity module 200.

FIG. 2B illustrates a more detailed communication flow of the above-described V2X authentication process. The connectivity unit 136 is shown to further comprise an identify application 252, an enrollment application 256, and a connectivity manager 260, while the OEM backend system 136 is shown to further comprise an identify manager 264, a V2X enrollment authority 268, and an enrollment CA 272. In the first phase (Phase 1), the hardware security module 204 initially performs self-tasks (e.g., creating digital identity keys and certificate signing requests). Next, the identify application 252, after a request to the hardware security module 204, sends a signed identity certificate request to the identity manager 264, which returns the signed identity (ID) certificate. The hardware security module 204 then saves the signed identity certificate.

In a subsequent second phase (Phase 2), the hardware security module 204 initially performs self-tasks (e.g., creating digital identity keys and certificate signing requests). Next, the enrollment application 256, after a request to the hardware security module 204, to get identity keys and certificates, securely connects and authenticates using identity keys and certificates with the V2X enrollment authority 268 and sends a V2X enrollment certificate request, which is forwarded on to the enrollment CA 272. When authenticated, the V2X enrollment certificate is returned by the V2X enrollment authority 268 to the enrollment application 256, which forwards the V2X enrollment certificate to the hardware security module 204 for validation and secure storage. The V2X enrollment status is then provided by the enrollment application 256 back to the V2X enrollment authority to complete the V2X enrollment process.

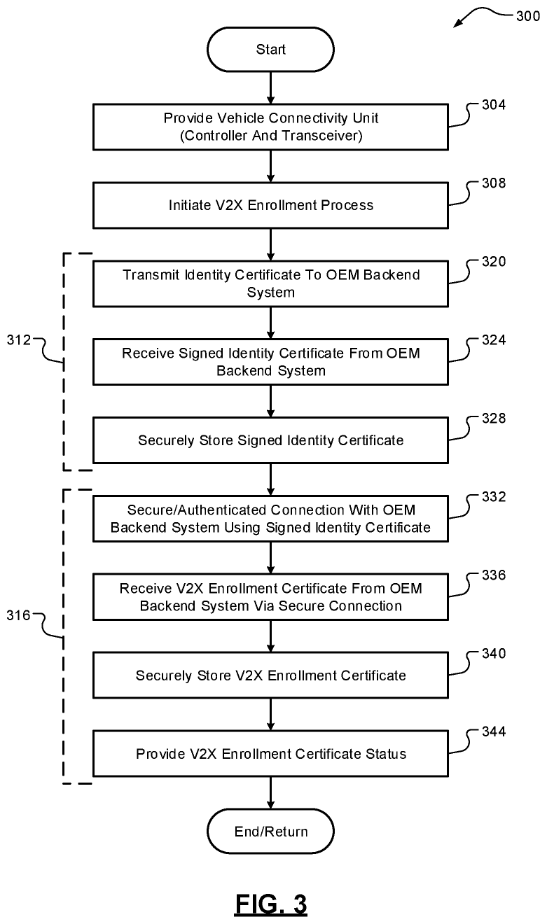

Referring now to FIG. 3, a flow diagram of an example V2X enrollment method 300 according to the principles of the present application is illustrated. It will be appreciated that while the components of vehicle 100 are specifically referenced for illustrative purposes, the method 300 could be applicable to any suitable vehicle/connectivity unit. At 304, the vehicle connectivity unit 120 (e.g., comprising the transceiver 124 configured for communication with other original equipment manufacturer OEM vehicle(s) 132 and the OEM backend system 136 and a controller 128 in communication with the transceiver 124) is provided. As previously mentioned, the connectivity unit 120 could be a generic-hardware connectivity unit provided or sourced from a third-party supplier that does not have access to the OEM backend system 136.

At 308, the vehicle connectivity unit 120 initiates a V2X enrollment process comprising first and second phases 312, 316. During the first phase 312, the vehicle connectivity unit 120 transmits an identity certificate request to the OEM backend system 136 at 320, receives a signed identity certificate from the OEM backend system 136 at 324, and securely stores the signed identity certificate at 328. During the second phase 316, the vehicle connectivity unit 120 securely connects and authenticating with the OEM backend system 136 using the signed identify certificate at 332, receives a V2X enrollment certificate from the OEM backend system 136 via the secure connection at 336, securely stores the V2X enrollment certificate at 340, and later provides the V2X enrollment certificate status to the OEM backend system 136 for future use in authorizing V2X communications. The method 300 then ends or returns to 304 for another cycle (e.g., on a subsequent production vehicle).

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vehicle-to-everything (V2X) communication system of a vehicle, the V2X communication system comprising:
a transceiver configured for communication with other original equipment manufacturer (OEM) vehicles and an OEM backend system; and
a controller in communication with the transceiver and configured to perform a V2X enrollment process including:
during a first phase:
transmitting an identity certificate request to the OEM backend system, and
receiving and securely storing a signed identity certificate from the OEM backend system; and
during a subsequent second phase:
securely connecting and authenticating with the OEM backend system using the signed identify certificate, and
receiving and securely storing a V2X enrollment certificate from the OEM backend system.

2. The V2X communication system of claim 1, wherein the controller is further configured to transmit a V2X enrollment status to the OEM backend system upon receiving and securely storing the V2X enrollment certificate.

3. The V2X communication system of claim 2, wherein transmitting the V2X enrollment status to the OEM backend system indicates that the V2X communication system is enrolled and authenticated for V2X communication with other same or different OEM vehicles and/or road-side units.

4. The V2X communication system, wherein the controller is part of a generic hardware vehicle connectivity unit.

5. The V2X communication system of claim 4, wherein the generic hardware vehicle connectivity unit is provided by a third-party supplier that does not have access to the OEM backend system.

6. A vehicle-to-everything (V2X) enrollment method for a vehicle, the method comprising:
providing a transceiver configured for communication with other original equipment manufacturer (OEM) vehicles and an OEM backend system and a controller in communication with the transceiver;
performing, by the controller and using the transceiver, a V2X enrollment process including:
during a first phase:
transmitting an identity certificate request to the OEM backend system, and
receiving and securely storing a signed identity certificate from the OEM backend system; and
during a subsequent second phase:
securely connecting and authenticating with the OEM backend system using the signed identify certificate, and
receiving and securely storing a V2X enrollment certificate from the OEM backend system.

7. The method of claim 6, further comprising transmitting, by the controller and using the transceiver, a V2X enrollment status to the OEM backend system upon receiving and securely storing the V2X enrollment certificate.

8. The method of claim 7, wherein transmitting the V2X enrollment status to the OEM backend system indicates that the V2X communication system is enrolled and authenticated for V2X communication with other same or different OEM vehicles and/or road-side units.

9. The method of claim 6, wherein the controller is part of a generic hardware vehicle connectivity unit.

10. The method of claim 9, wherein the generic hardware vehicle connectivity unit is provided by a third-party supplier that does not have access to the OEM backend system.
